(19) United States
(12) Patent Application Publication
(10) Pub. No.: US 2016/0032844 A1
(43) Pub. Date: Feb. 4, 2016

(54) IC ENGINE CYLINDER AND PISTON

(71) Applicants: Grzegorz Siuchta, Des Plaines, IL (US); Dean Alan Oppermann, Plainfield, IL (US)

(72) Inventors: Grzegorz Siuchta, Des Plaines, IL (US); Dean Alan Oppermann, Plainfield, IL (US)

(73) Assignee: International Engine Intellectual Property Company , LLC, Lisle, IL (US)

(21) Appl. No.: 14/881,757

(22) Filed: Oct. 13, 2015

Related U.S. Application Data
(63) Continuation-in-part of application No. 14/354,072, filed on Apr. 24, 2014.

(51) Int. Cl. F02D 15/04; F02B 43/10; F02F 3/28

(52) U.S. Cl. CPC F02D 15/04; F02F 3/28; F02B 43/10; F02B 2043/103

(57) ABSTRACT

An internal combustion engine has at least one engine cylinder which is closed at an end by a cylinder head and within which a piston reciprocates. The cylinder head has a plunger receptacle and the piston has a plunger which, when the piston is reciprocating within the engine cylinder over an engine cycle's range between BDC and an intermediate position spaced from both TDC and BDC, fully opens the plunger receptacle to the interior of the engine cylinder, and which, when the piston is reciprocating over an engine cycle's range between the intermediate position and TDC position, enters the plunger receptacle to compress an air-fuel mixture at higher compression ratio in the plunger receptacle where it is ignited and subsequently used to ignite the rest of the mixture during piston downstroke.

### REFERENCE TO RELATED APPLICATION AND PRIORITY CLAIM

This application is a continuation-in-part of pending patent application Ser. No. 14/354,072 filed on Apr. 24, 2014, which claims priority of PCT/US12/33793 filed on Apr. 16, 2012 which claims priority of 61/560,882 filed on Nov. 17, 2011. The entire contents of each of these three patent applications listed in the previous sentence are incorporated herein by this reference

### TECHNICAL FIELD

The subject matter of the present disclosure relates generally to an internal combustion engine of the type having engine cylinders within which pistons reciprocate. The disclosed subject matter relates particularly to an engine cylinder and a piston which, as the latter is approaching top dead center (TDC) position, cooperate in forming variable volume first and second combustion chamber spaces which are isolated from each other and which have different compression ratios at TDC position.

### BACKGROUND

When a power plant of a motor vehicle is a spark-ignited internal combustion engine, one of the controls for the engine is a throttle in the intake system. Throttling of the engine enables it to operate at speeds and torques which are less than the maximum speed and maximum torque which the engine is capable of attaining. However, when the engine is running at part throttle, the throttle imposes a restriction which contributes to engine inefficiency due to engine pumping losses.

In certain engines, the throttle can be controlled in conjunction with control of fueling to create in-cylinder fuel/air charges which have substantially stoichiometric fuel/air ratios, a feature which may be useful for exhaust after-treatment.

Certain engines, such as those which use natural gas as a primary fuel (NG engines), operate at lean or stoichiometric with exhaust gas recirculation (EGR). The presence of excess air or EGR in a fuel/air charge tends to render the charge difficult to ignite. To assure charge ignition, it is known to create a precombustion chamber space within an engine cylinder into which fuel, which may be other than natural gas (diesel fuel, for example) is injected to create a localized rich mixture which is more easily ignited to initiate combustion of the lean mixture in the cylinder. An NG, spark-ignited (SI), engine operating at lean air/fuel mixtures (Air/Fuel ratio above stoichiometric ratio) or an NG, SI, engine operating at stoichiometric ratio of air/fuel mixtures diluted with higher EGR levels can offer improved engine performance and efficiency, but such mixtures are difficult to ignite.

An engine which runs with little or no exhaust gas recirculation, such as an NG engine, tends to be prone to combustion knock which in the case of a turbocharged engine limits engine boost and hence affects engine performance and efficiency.

### SUMMARY OF THE DISCLOSURE

A general aspect of the present disclosure relates to an internal combustion engine which comprises an engine cylinder which has a lengthwise extending central axis and an interior within which an air-fuel mixture which has been introduced into the engine cylinder combusts to power the engine; a cylinder head closing an axial end of the engine cylinder; a piston which, during engine cycles, reciprocates axially within the engine cylinder between a TDC (top dead center) position and a BDC (bottom dead center) position and which comprises a piston head confronting the cylinder head; the cylinder head and the piston head collectively comprising a plunger receptacle in one of the cylinder head and the piston head, and in the other of the cylinder head and the piston head, a plunger a) which when the piston is reciprocating over an engine cycle's range between BDC position and a first intermediate position spaced from both TDC position and BDC position, fully opens the plunger receptacle to the interior of the engine cylinder, b) which when the piston is reciprocating over an engine cycle's range between the first intermediate position and a second intermediate position which is spaced between the first intermediate position and TDC position, cooperates with the plunger receptacle to form a variable volume first combustion chamber space within which the plunger, without substantially fully closing the first combustion chamber space to a second combustion chamber space which is axially bounded by mutually confronting surfaces of the cylinder head and the piston head which exclude the plunger receptacle and the plunger, compresses air-fuel mixture at a first rate of compression during piston upstroke from the first intermediate position toward the second intermediate position while the piston is compressing air-fuel mixture in the second combustion chamber space at a second rate of compression which is less than the first rate of compression, and c) which when the piston is reciprocating over an engine cycle's range between the second intermediate position and TDC position, cooperates with the plunger receptacle to substantially fully close the first combustion chamber space to the second combustion chamber space and compresses, during piston upstroke from the second intermediate position toward TDC position, air-fuel mixture in the first combustion chamber space at a rate of compression which is at least as great as the first rate of compression and which continues to exceed the rate of compression at which the piston is compressing air-fuel mixture in the second combustion chamber space.

Other general aspects relate to methods of operating the disclosed engine.

Still another general aspect relates to a method of igniting a stoichiometric measure of air and natural gas which is sufficiently diluted by excess air and/or engine exhaust gas to create a dilute mixture whose reactivity, if uniformly maximally compressed within an engine cylinder of an internal combustion engine would be incapable of being ignited by either compression- or spark-ignition.

The method is performed in an internal combustion engine having an engine cylinder which has a lengthwise extending central axis and within an interior of which combustion occurs to power the engine, a cylinder head closing an axial end of the engine cylinder, a piston which, during engine cycles, reciprocates axially within the engine cylinder's interior between a TDC position and a BDC position and which comprises a piston head confronting the cylinder head, the cylinder head and the piston collectively comprising a plunger receptacle in one of the cylinder head and the piston head, and in the other of the cylinder head and the piston head, a plunger which, when the piston is reciprocating over an engine cycle's range between BDC position and an intermediate position spaced from both TDC position and BDC position, fully opens the plunger receptacle to the interior of the engine cylinder, and which, when the piston is reciprocating over an engine cycle's range between the intermediate position and TDC position, forms a variable volume first combustion chamber space which is cooperatively defined between the plunger and the plunger receptacle and which is substantially closed from a variable volume second combustion chamber space which is axially bounded by mutually confronting surfaces of the cylinder head and the piston head which exclude the plunger receptacle and the plunger.

The method comprises:

when piston position is within the engine cycle's range between BDC position and the intermediate position, introducing into the interior of the engine cylinder, a stoichiometric measure of air and natural gas which is sufficiently diluted by excess of air and/or engine exhaust gas to create a dilute mixture whose reactivity, when uniformly maximally compressed within the second combustion chamber space, is incapable of being ignited by either compression- or spark-ignition;

compressing the dilute mixture as the piston upstrokes toward the intermediate position, and as the piston upstrokes from the intermediate position toward TDC position, compressing the dilute mixture within the first combustion chamber space at a first rate of compression to create pressure which enables the dilute mixture in the first combustion chamber to be ignited by compression- or spark-ignition when the piston is at or near TDC position, and compressing the dilute mixture within the second combustion chamber space at a second rate of compression which is less than the first rate of compression to create a maximum pressure in the second combustion chamber space which does not ignite the dilute mixture within the second combustion chamber space;

igniting the mixture in the first combustion chamber space by one of spark-ignition and compression-ignition while piston position is between TDC position and the intermediate position; and

during a subsequent downstroke of the piston from TDC when the first combustion chamber space ceases to be substantially closed to the second combustion chamber space, allowing ignited mixture to pass from the first combustion chamber space to enter the second combustion chamber space and ignite dilute mixture in the second combustion chamber space.

The foregoing summary is accompanied by further detail of the disclosure presented in the Detailed Description below with reference to the following drawings which are part of the disclosure.

### BRIEF DESCRIPTION OF THE DRAWINGS

FIG. 1 is a diagram of a portion of an internal combustion engine which shows an engine cylinder and a piston which reciprocates within the engine cylinder between BDC position and TDC position.

FIG. 2 is a diagram like FIG. 1, but showing the piston in a position intermediate to the BDC position and the TDC position.

FIG. 3 is a diagram like FIG. 2, but showing the piston in TDC position.

FIG. 4 is a schematic diagram of an exemplary embodiment of engine system in which an internal combustion engine has one or more engine cylinders like the one described in FIGS. 1-3

FIG. 5 is a top plan view showing another embodiment of piston.

FIG. 6 is a cross section view in the direction of arrows 6-6 in FIG. 5 and also showing the engine cylinder.

FIG. 7 is an enlarged fragmentary view in the direction of arrow 7 in FIG. 5.

### DETAILED DESCRIPTION

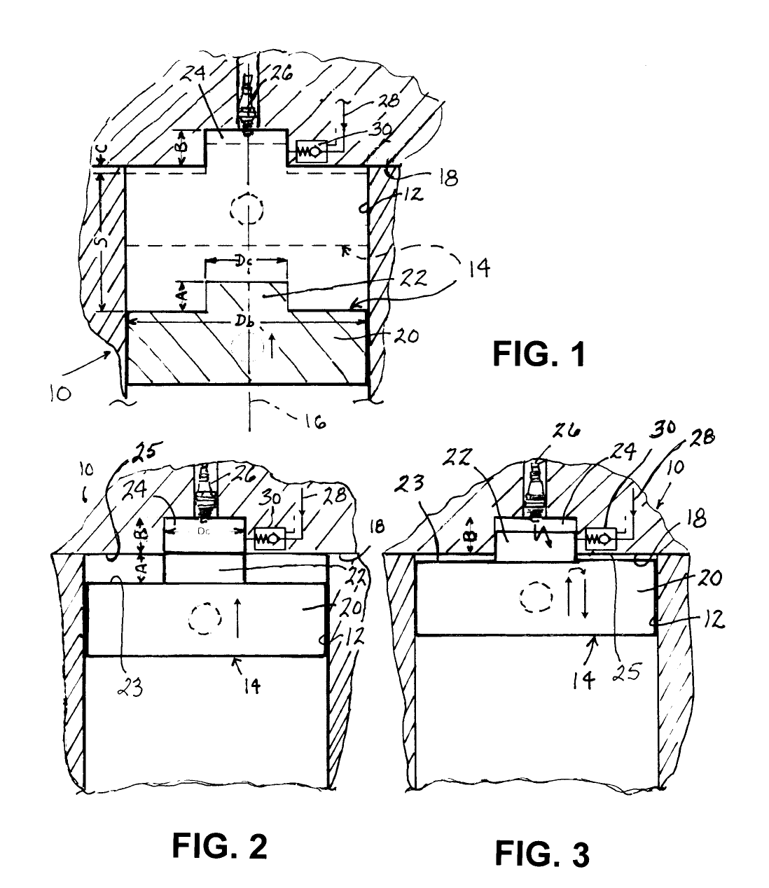

FIG. 1 shows a portion of an internal combustion engine 10 which may be used as the powerplant of a motor vehicle such as a truck (not shown in the drawing) for propelling the motor vehicle.

Engine 10 comprises multiple engine cylinders 12, like the single one illustrated, within the interior of each of which a respective piston 14 reciprocates. Certain other components which are present, such as cylinder intake and exhaust valves for example, are not illustrated.

Engine cylinder 12 has a lengthwise extending central axis 16 and an interior within which combustion occurs to power the engine. Engine 10 comprises a cylinder head 18 which closes an axial end of engine cylinder 12. Piston 14 reciprocates axially within engine cylinder 12 between TDC position (shown in broken lines) and BDC position (shown in solid lines) and comprises a piston head 20 confronting cylinder head 18.

Piston 14 comprises a plunger 22 which is coaxial with axis 16 and which extends axially upwardly away from a surrounding annular top surface 23 of piston head 20 which confronts a mutually confronting annular bottom surface 25 of cylinder head 18. Plunger 22 has a circular cylindrical side surface and a flat end surface which is perpendicular to the side surface, although the end surface may have a shape other than flat, such as a concave or a convex shape.

Cylinder head 18 comprises a plunger receptacle 24 which is coaxial with axis 16 and which extends axially inward from the annular bottom surface 25 of cylinder head 18 which confronts the annular top surface 23 of piston head 20. Plunger receptacle 24 has a circular cylindrical side surface and a flat end surface which is perpendicular to the side surface although the end surface may have a shape other than flat.

When piston 14 is reciprocating over an engine cycle's range between BDC position and an intermediate position (shown in FIG. 2) spaced from both TDC position and BDC position, plunger receptacle 24 is fully open to the interior of engine cylinder 12 below the annular bottom surface 25 of cylinder head 18 which confronts the annular top surface 23 of piston head 20. When piston 14 is reciprocating over an engine cycle's range between the intermediate position shown in FIG. 2 and TDC position, plunger 22 cooperates with plunger receptacle 24 to form a variable volume first combustion chamber space which is substantially closed to a variable volume second combustion chamber space which is cooperatively defined between the mutually confronting annular bottom surface 25 of cylinder head 18 and annular top surface 23 of piston head 20.

When the position of piston 14 is within the engine cycle's range between BDC position and the intermediate position, an air-fuel mixture is introduced into engine cylinder 12, including plunger receptacle 24. The air-fuel mixture can be created and introduced in any suitably appropriate way. As piston 14 upstrokes toward the intermediate position, it uniformly compresses the mixture.

Arrival of piston 14 at the intermediate position defines a corresponding compression ratio for engine cylinder 12. As piston 14 continues to upstroke, it passes through the intermediate position at which plunger 22 begins to enter plunger receptacle 24, substantially closing the first combustion chamber space to the second combustion chamber space.

As piston 14 continues to upstroke over the engine cycle's range from the intermediate position toward TDC position, the side surfaces of plunger 22 and plunger receptacle 24 radially confront each other with a close sliding clearance which is effective to sufficiently contain the air-fuel mixture in the first combustion chamber space for further compression at a first rate of compression while the mixture contained within the second combustion chamber space is also further compressed, but at a second rate which is significantly less than that in the first combustion chamber space.

The collective geometry of engine cylinder 12, piston 14, cylinder head 18, plunger receptacle 24, and plunger 22 provide, at TDC position shown in FIG. 3, a compression ratio for the first combustion chamber space which is greater than a compression ratio for the second combustion chamber space.

Engine 10 also comprises an igniter, such as a conventional automotive spark plug 26, for creating an igniting spark in the first combustion chamber space to ignite the charge in the first combustion chamber space. The igniter is considered an optional device whose presence or absence is conditioned on specific cylinder/piston configuration and particular fuel combusted. When spark ignition is used to ignite the mixture in the first combustion chamber space, the engine cylinder may be considered as spark-ignited (SI) cylinder. When compression-ignition (autoignition) is used to ignite the mixture in the first combustion chamber space, the engine cylinder may be considered as compression-ignited (autoignited) cylinder.

Engine 10 also comprises a fuel supply passage 28 which is open to the first combustion chamber space and through which fuel can be introduced into the first combustion chamber space. Fuel supply passage 28 comprises a check 30 for preventing backflow from the first combustion chamber space to a portion of the fuel supply passage upstream of the check. Fuel supply passage 28 opens to the first combustion chamber space at a location which is occluded by plunger 22 as piston 14 is reciprocating over an engine cycle's range between TDC position and a position between the intermediate position shown in FIG. 2 and TDC position shown in FIG. 3. It is to be appreciated that certain engines are capable of igniting highly diluted cylinder charges without the use of additional fuel supplied by a fuel supply passage 28, thereby rendering the use of fuel supply passage 28 optional in such engines.

A specific example is given by dimensions marked in the Figures where S is the stroke of piston 14 as measured between BDC position and TDC position; Db is the diameter of piston head 20, Dc is the diameter of plunger 22, A is the axial length of plunger 22, B is the axial length of plunger receptacle 24, and C is the axial distance between the mutually confronting surfaces of piston head 20 and cylinder head 18 when piston 14 is at TDC position.

The compression ratio (CR1) at the intermediate position of piston 14 shown in FIG. 2 is given by the following formula:

CR1=((C+S*Db²+(B−A)*Dc²)/(B*Dc²)+A*(Db−Dc)²

The compression ratio (CRp) in the first combustion chamber space when piston 14 is at TDC position is given by the following formula:

CRp=CR1*B/(B+C−A)

The compression ratio CRm in the second combustion chamber space when piston 14 is at TDC position is given by the following formula:

CRm=CR1*(A/C)

For values of S=119 mm., Db=116 mm., A=23 mm., B=9 mm., and Dc=23 mm., which are representative dimensions for an I466 Diesel engine converted into an NG engine, CR1=˜9, CRp=˜14, and CRm=˜11.

The more highly compressed mixture in the first combustion chamber space possesses significantly greater reactivity than does the less compressed mixture in the second combustion chamber space. Consequently, the more highly compressed mixture can be ignited, either by autoignition or by spark, with or without extra fueling from fuel supply passage 28. The ignited mixture is used to subsequently ignite the lower reactivity mixture within the second combustion chamber space of engine cylinder 12 upon plunger 22 leaving plunger receptacle 24 during piston downstroke.

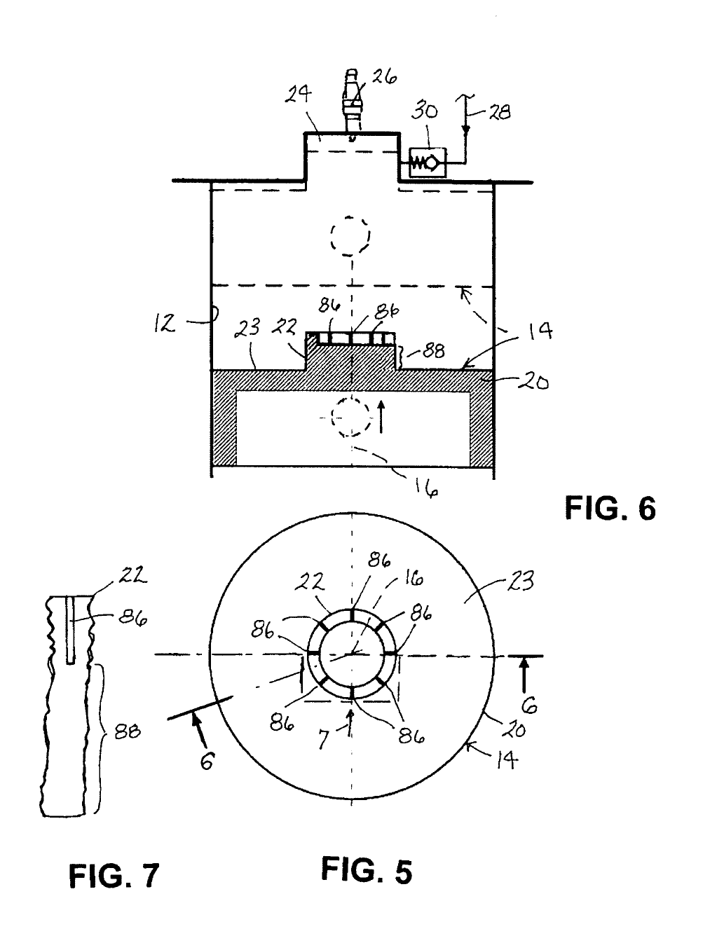

The perimeter rim of plunger 22 may however have a shape other than circular; for example it may be castellated, as will be more fully explained with reference to FIGS. 5-7, to provide small cuts through which flame jets resulting from ignition of the charge in the first combustion chamber space can pass to ignite of the portion of the mixture in the second combustion chamber space prior to plunger 22 leaving plunger receptacle 24.

The subject matter of this disclosure can endow an SI IC engine with reliable ignition and combustion of very lean (significant excess of air) and/or highly diluted with EGR, air/fuel (Natural Gas) mixtures. The engine may operate with a higher EGR rate and cooler EGR, enabling it to have a larger compression ratio for better engine performance and efficiency with lower exhaust temperatures. Intake throttle usage may be eliminated or reduced to mitigate pumping losses. Knock combustion may be eliminated or reduced. Possible reductions in spark energy for mixture ignition may improve spark plug durability.

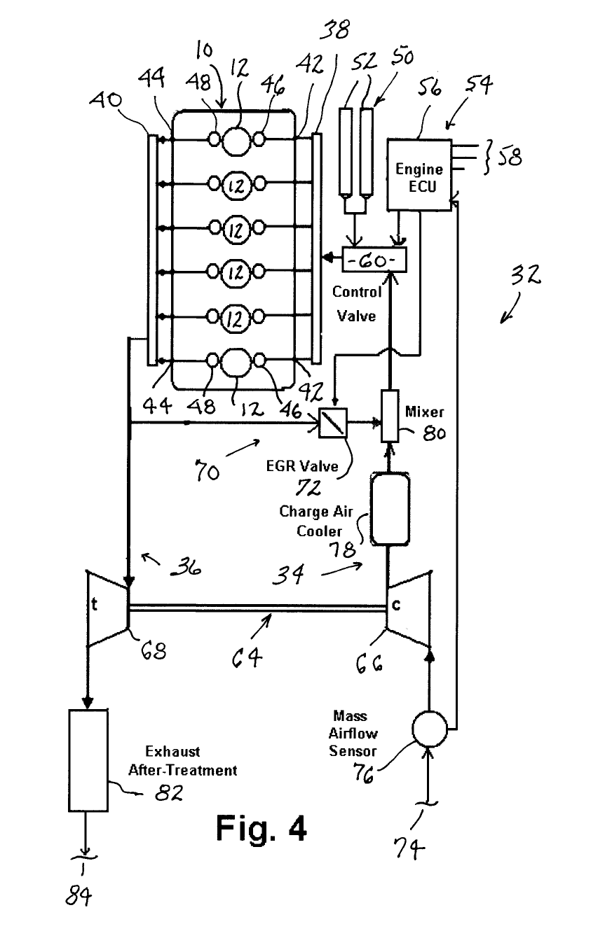

FIG. 4 illustrates one example of an engine system 32 comprising an engine 10 which has six engine cylinders 12 each of which is like the one shown in FIGS. 1-3. Engine system 32 has an intake system 34 through which fresh air is introduced into engine cylinders 12 and an exhaust system 36 through which exhaust gas leaves engine cylinders 12. An engine intake manifold 38 is part of intake system 34, and an engine exhaust manifold 40 is part of exhaust system 36.

Each engine cylinder 12 has an intake port 42 open to intake manifold 38 and an exhaust port 44 open to exhaust manifold 40. Each engine cylinder 12 also has one or more cylinder intake valves 46 which are operable to open and close the engine cylinder to its intake port 42 at appropriate times during each engine cycle. Likewise, one or more cylinder exhaust valves 48 are operable to open and close the respective engine cylinder to its exhaust port 44 at appropriate times during each engine cycle.

Engine system 32 has a fueling system 50 which uses natural gas as the primary fuel. Natural gas is stored under pressure in one or more gas storage cylinders 52. Engine system 32 also has an engine control system 54 which includes an engine electronic control unit (engine ECU) 56 which controls various devices of the engine system.

Natural gas is delivered from storage cylinders 52 at a mass flow rate calculated by engine ECU 56 based on one or more control inputs 58, one of which is an input which requests the engine to produce a particular value of an engine output parameter, such as engine torque. A control valve 60 controlled by engine ECU 56 is disposed between storage cylinders 52 and intake system 34 to cause a desired mass flow rate of natural gas to enter intake system 34.

Natural gas introduced into intake system 34 via control valve 60 entrains with fresh air passing through intake system 34, and as will be subsequently explained, also with any exhaust gas being recirculated. The entrainment creates an air-fuel mixture which will be combusted in engine cylinders 12. During intake valve opening of each engine cylinder, a quantity of the air-fuel mixture enters the engine cylinder.

Engine system 32 further comprises a turbocharger 64 having a compressor 66 as part of intake system 34 and a turbine 68 as part of exhaust system 36. Recirculation of engine exhaust gas from exhaust system 36 to intake system 34 is controlled by an exhaust gas recirculation (EGR) system 70 having an EGR valve 72.

Intake system 34 comprises a fresh air inlet 74 and a mass airflow sensor 76 through which fresh air passes to an inlet of compressor 66. Charge air created by compressor 66 passes from an outlet of compressor 66 through a charge air cooler 78 to a first inlet of a mixer 80 having a second inlet for any exhaust gas being recirculated. An outlet from mixer 80 is communicated to intake manifold 38, and it is between that outlet and intake manifold 38 that control valve 60 introduces natural gas into the flow coming from mixer 80. Mass airflow sensor 76 provides data to engine ECU 56 which calculates a proper flow rate control valve 60 to introduce natural gas into the flow from mixer 80 so that a desired air-fuel ratio is created in intake manifold 38. Engine ECU 56 may also take into account any EGR flow. In this way proper air and/or EGR dilution of the mixture entering engine cylinders 12 can be achieved.

Exhaust system 36 communicates exhaust manifold 40 to an inlet of turbine 68 and to an inlet of EGR valve 72. An outlet of turbine 68 is communicated to an inlet of an exhaust after-treatment system 82, and an outlet of exhaust after-treatment system 82 is communicated to an exhaust outlet 84.

An engine which has engine cylinders as disclosed herein can ignite a stoichiometric measure of air and natural gas which is sufficiently diluted by one or more of excess air and engine exhaust gas to create a dilute mixture whose low reactivity, if uniformly maximally compressed within an engine cylinder of a standard internal combustion engine would be incapable of being ignited by either compression- or spark-ignition. It should be understood that a stoichiometric measure of air and natural gas which is diluted by excess air is actually operating at a lean air-fuel ratio (i.e., air-fuel ratio above stoichiometric ratio), and would be considered a lean-burn type of engine.

Performance and efficiency of engines whose engine cylinders uniformly maximally compress a stoichiometric air-fuel ratio diluted with EGR is limited by the EGR rate because such mixtures become more difficult to reliably ignite as EGR rate increases. While performance of an engine which has engine cylinders as disclosed herein is also limited by EGR rate, the limit is greater for given levels of engine performance and efficiency. The engines operating at stoichiometric air-fuel ratio allow application of very effective 3-way catalyst emissions after-treatment systems.

Engine systems embodying the disclosed engine cylinders can have various configurations for intake and exhaust systems and can have an exhaust after-treatment system appropriate for each configuration.

FIGS. 5-7 illustrate the castellated plunger version alluded to earlier. The same reference numerals in FIGS. 5-7 identify the same elements as in FIGS. 1-3, and the castellated plunger version differs from the non-castellated version in FIGS. 1-3 only in the construction of the plunger. However because of that difference, the method of igniting the diluted mixture in the second combustion chamber space is significantly different.

The circular cylindrical side surface of plunger 22 has an axial length a portion of which extending from the plunger's end surface is interrupted by at least one radially inward cut 86. The particular embodiment shown has multiple axially extending cuts 86 spaced circumferentially apart around the plunger. Each cut has an axial length which is parallel with central axis 16 and which is also less than the axial length of the plunger's side surface, thereby leaving a portion 88 of the plunger's side surface axially beyond the cuts toward surface 23 uninterrupted.

During upstroke from BDC, piston 14 arrives at a first intermediate position when the end of plunger 22 first enters plunger receptacle 24. As the upstroke continues, piston 14 arrives at a second intermediate position spaced from TDC when the uninterrupted portion 88 of the plunger's side surface first enters plunger receptacle 24. As piston 14 upstrokes from the first intermediate position to the second intermediate position, cuts 86 provide restricted communication of the first combustion chamber space to the second combustion chamber space, thereby preventing plunger 22 from substantially fully closing the first combustion chamber space to the second combustion chamber space. Hence, as plunger 22 upstrokes from the first intermediate position to the second intermediate position, the restricted communication between the two combustion chamber spaces does not substantially fully close the first combustion chamber space to the second combustion chamber space although the mixture in the first combustion chamber space is nonetheless being increasingly compressed. The restricted communication is sufficiently small that the mixture in the first combustion chamber space is compressed at a greater rate of compression than the rate of compression of the mixture in the second combustion chamber space.

During piston upstroke from the second intermediate position to TDC, entry of the uninterrupted portion 88 of the plunger's side surface into plunger receptacle 24 causes plunger 22 to substantially fully close the first combustion chamber space to the second combustion chamber space and increasingly compress the mixture in the first combustion chamber space at a rate greater than that at which the mixture in the second combustion chamber space is being compressed.

Ignition of the mixture in the first combustion chamber space occurs at or near TDC while the uninterrupted portion 88 of the plunger's side surface remains within plunger receptacle 24. As piston 14 downstroke from TDC reaches the second intermediate position, uninterrupted portion 88 of the plunger's side surface exits the first combustion chamber space to open cuts 86 to the second combustion chamber space. The great pressure difference between the ignited mixture in the first combustion chamber space and the unignited mixture in the second combustion chamber space causes jets of flame to be emitted out of cuts 86 into the second combustion chamber space and ignite the mixture in the second combustion chamber space. Cuts 86 enable the creation of flame jets which have significantly greater velocity and distinctive radial directionality as they enter the second combustion chamber space in comparison to how the ignited mixture in the non-castellated version enters the second combustion chamber space.

What is claimed is:

1. An internal combustion ignition engine comprising:
an engine cylinder which has a lengthwise extending central axis and an interior within which an air-fuel mixture which has been introduced into the engine cylinder combusts to power the engine;
a cylinder head closing an axial end of the engine cylinder;
a piston which, during engine cycles, reciprocates axially within the engine cylinder between a TDC position and a BDC position and which comprises a piston head confronting the cylinder head;
the cylinder head and the piston head collectively comprising a plunger receptacle in one of the cylinder head and the piston head, and in the other of the cylinder head and the piston head, a plunger a) which when the piston is reciprocating over an engine cycle's range between BDC position and a first intermediate position spaced from both TDC position and BDC position, fully opens the plunger receptacle to the interior of the engine cylinder, b) which when the piston is reciprocating over an engine cycle's range between the first intermediate position and a second intermediate position which is spaced between the first intermediate position and TDC position, cooperates with the plunger receptacle to form a variable volume first combustion chamber space within which the plunger, without substantially fully closing the first combustion chamber space to a second combustion chamber space which is axially bounded by mutually confronting surfaces of the cylinder head and the piston head which exclude the plunger receptacle and the plunger, compresses air-fuel mixture at a first rate of compression during piston upstroke from the first intermediate position toward the second intermediate position while the piston is compressing air-fuel mixture in the second combustion chamber space at a second rate of compression which is less than the first rate of compression, and c) which when the piston is reciprocating over an engine cycle's range between the second intermediate position and TDC position, cooperates with the plunger receptacle to substantially fully close the first combustion chamber space to the second combustion chamber space and compresses, during piston upstroke from the second intermediate position toward TDC position, air-fuel mixture in the first combustion chamber space at a rate of compression which is at least as great as the first rate of compression and which continues to exceed the rate of compression at which the piston is compressing air-fuel mixture in the second combustion chamber space

2. The internal combustion engine as set forth in claim 1 in which the plunger extends axially outward from the mutually confronting surface of the piston head and the plunger receptacle extends axially inward from the mutually confronting surface of the cylinder head.

3. The internal combustion engine as set forth in claim 2 in which the plunger receptacle has an end surface and a side surface extending axially away from the end surface, the plunger has an end surface facing the end surface of the plunger receptacle and a side surface which radially confronts the side surface of the plunger receptacle as the piston is reciprocating between the first intermediate position and TDC position, the side surface of the plunger having an axial extent which extends from the plunger's end surface and which is interrupted by at least one radially inward cut which, as the piston is reciprocating between the first intermediate position and the second intermediate position provides communication between the first combustion chamber space and the second combustion chamber space which prevents the plunger from substantially fully closing the first combustion chamber space to the second combustion chamber space.

4. The internal combustion engine as set forth in claim 3 in which the plunger and the plunger receptacle are coaxial with the central axis, the side surfaces of the plunger and of the plunger receptacle have circular cylindrical shapes, and the at least one cut has an axial extent which is less than the axial length of the plunger's side surface and leaves an axial extent of the plunger's side surface beyond the at least one cut uninterrupted.

5. The internal combustion engine as set forth in claim 4 in which the uninterrupted axial extent of the plunger's side surface has a greater axial extent than the axial extent of the plunger's side surface which is interrupted by the at least one cut.

6. The internal combustion engine as set forth in claim 5 in which the uninterrupted axial extent of the plunger's side surface and the axial extent of the plunger's side surface which is interrupted by the at least one cut have identical diameters.

7. The internal combustion engine as set forth in claim 6 in which the at least one cut comprises multiple axially extending cuts spaced circumferentially apart around the plunger.

8. The internal combustion engine as set forth in claim 7 in which the cuts have axial lengths which are parallel with the central axis.

9. The internal combustion engine as set forth in claim 3 further comprising a fuel supply passage which is open to the first combustion chamber space and through which fuel can be introduced into the first combustion chamber space.

10. The internal combustion engine as set forth in claim 9 in which the fuel supply passage comprises a check for preventing backflow from the first combustion chamber space to a portion of the fuel supply passage upstream of the check.

11. The internal combustion engine as set forth in claim 10 in which the fuel supply passage opens to the first combustion chamber space at a location which is occluded by the plunger as the piston is reciprocating over the engine cycle's range between TDC position and a position between the second intermediate position and TDC position.

12. The internal combustion engine as set forth in claim 9 further comprising an igniter for creating a spark to ignite the compressed air-fuel mixture in the first combustion chamber space.

13. The internal combustion engine as set forth in claim 1 in which the collective geometry of the engine cylinder, the piston, the cylinder head, the plunger receptacle and the plunger causes, during piston upstroke between the first intermediate position and TDC position, compression of the air-fuel mixture in the first combustion chamber space to increase at a rate which is greater than the rate at which the piston is causing compression of the air-fuel mixture in the second combustion chamber space to increase.

14. A method of operating the internal combustion engine set forth in claim 1 comprising, when piston position is within the engine cycle's range between BDC position and the first intermediate position, introducing an air-fuel mixture into the interior of the engine cylinder, compressing the air-fuel mixture as the piston upstrokes toward the first intermediate position, and when the piston upstrokes from the first intermediate position toward TDC position, compressing air-fuel mixture in the first combustion chamber space at a first rate of compression and compressing air-fuel mixture in the second combustion chamber space at a second rate of compression which is less than the first rate of compression.

15. A method of operating the internal combustion engine set forth in claim 2 comprising, when piston position is within the engine cycle's range between BDC position and the first intermediate position, introducing an air-fuel mixture into the interior of the engine cylinder, compressing the air-fuel mixture as the piston upstrokes toward the first intermediate position, and when the piston upstrokes from the first intermediate position toward TDC position, compressing air-fuel mixture in the first combustion chamber space at a first rate of compression and compressing air-fuel mixture in the second combustion chamber space at a second rate of compression which is less than the first rate of compression.

16. The method of operating the internal combustion engine as set forth in claim 15 further comprising causing ignition of the air-fuel mixture in the first combustion chamber space when piston position is within the engine cycle's range between the second intermediate position and TDC position, and once the piston reaches the second intermediate position during downstroke, allowing ignited mixture to pass from the first combustion chamber space through the at least one cut to ignite air-fuel mixture in the second combustion chamber space.

17. The method of operating the internal combustion engine as set forth in claim 15 further comprising introducing fuel into the first combustion chamber space through a fuel inlet to the plunger receptacle during upstroke of the piston from the first intermediate position toward TDC position.

18. A method of igniting a stoichiometric measure of air and natural gas which is sufficiently diluted by excess air and/or engine exhaust gas to create a dilute mixture whose reactivity, if uniformly maximally uniformly compressed within an engine cylinder of an internal combustion engine would be incapable of being ignited by either compression- or spark-ignition, the method comprising:
in an internal combustion engine having an engine cylinder which has a lengthwise extending central axis and within an interior of which combustion occurs to power the engine, a cylinder head closing an axial end of the engine cylinder, a piston which, during engine cycles, reciprocates axially within the engine cylinder's interior between a TDC position and a BDC position and which comprises a piston head confronting the cylinder head, the cylinder head and the piston collectively comprising a plunger receptacle in one of the cylinder head and the piston head, and in the other of the cylinder head and the piston head, a plunger which, when the piston is reciprocating over an engine cycle's range between BDC position and an intermediate position spaced from both TDC position and BDC position, fully opens the plunger receptacle to the interior of the engine cylinder, and which, when the piston is reciprocating over an engine cycle's range between the intermediate position and TDC position, forms a variable volume first combustion chamber space which is cooperatively defined between the plunger and the plunger receptacle and which is substantially closed from a variable volume second combustion chamber space which is axially bounded by mutually confronting surfaces of the cylinder head and the piston head which exclude the plunger receptacle and the plunger;
when piston position is within the engine cycle's range between BDC position and the intermediate position, introducing into the interior of the engine cylinder a stoichiometric measure of air and natural gas which is sufficiently diluted by excess air and/or engine exhaust gas to create a dilute mixture whose reactivity, when uniformly maximally compressed within the second combustion chamber space, is incapable of being ignited by either compression- or spark-ignition;
compressing the dilute mixture as the piston upstrokes toward the intermediate position, and as the piston upstrokes from the intermediate position toward TDC position, compressing the dilute mixture within the first combustion chamber space at a first rate of compression to create pressure which enables the mixture in the first combustion chamber space to be ignited by compression- or spark-ignition when the piston is at or near TDC position, and compressing the dilute mixture within the second combustion chamber space at a second rate of compression which is less than the first rate of compression to create a maximum pressure in the second combustion chamber space which does not ignite the dilute mixture within the second combustion chamber space;
igniting the mixture in the first combustion chamber space by one of spark-ignition and compression-ignition while piston position is between TDC position and the intermediate position; and
during a subsequent downstroke of the piston from TDC when the first combustion chamber space ceases to be substantially closed to the second combustion chamber space, allowing ignited mixture to pass from the first combustion chamber space to enter the second combustion chamber space and ignite dilute mixture in the second combustion chamber space.

19. The method as set forth in claim 18 further comprising introducing fuel from an external source into the first combustion chamber space during piston upstroke from the intermediate position toward TDC position.

20. The method as set forth in claim 18 in which during subsequent downstroke of the piston from TDC when the first combustion chamber space ceases to be substantially closed to the second combustion chamber space, allowing ignited mixture to pass from the first combustion chamber space to enter the second combustion chamber space through at least one cut in a side surface of the plunger and ignite dilute mixture in the second combustion chamber space.
